(19) United States
(12) Patent Application Publication
(10) Pub. No.: US 2023/0273118 A1
(43) Pub. Date: Aug. 31, 2023

(54) MEASURING SYSTEM AND MEASURING METHOD

(71) Applicant: COURAGE + KHAZAKA ELECTRONIC GMBH, Köln (DE)

(72) Inventors: Carina REBLE, Berlin (DE); Georg WIORA, Köln (DE)

(73) Assignee: COURAGE + KHAZAKA ELECTRONIC GMBH, Köln (DE)

(21) Appl. No.: 18/005,604

(22) PCT Filed: Jul. 14, 2021
(86) PCT No.: PCT/EP2021/069615

§ 371 Date: Jan. 15, 2023

(30) Foreign Application Priority Data
Jul. 17, 2020 (DE) 10 2020 119 026.3

(51) Int. Cl. G01N 21/31

(52) U.S. Cl. CPC G01N 21/31

(57) ABSTRACT

The invention describes a method for determining sun protection factors of sunscreen agents with a spectroscopic measurement comprising the following steps: first activation of several radiation sources of a radiation source device having at least two radiation sources, first emission of radiation from the at least two radiation sources, detection of the radiation diffusely reflected by a measuring body, determination of the sensor sensitivity S_{T} of a detector, determining the target exposure time t_{Z} and/or the target light power l_{Z} for the at least two radiation sources, second driving of a plurality of radiation sources of the radiation source device having at least two radiation sources, second emission of radiation from the at least two radiation sources with a target exposure time t_{Z} and/or the target light power l_{Z} of the first and the second radiation source of the radiation source device.

The invention describes a method for determining sun protection factors of sunscreen agents with a spectroscopic measurement with the following method steps: first control of several radiation sources of a radiation source device having at least two radiation sources, first emission of radiation from the at least two radiation sources, detection of the radiation remitted by a measuring body, determination of the sensor sensitivity S_{T} of a detector, determining the target exposure time t_{Z} and/or the target light power l_{Z} for the at least two radiation sources, second activation of a plurality of radiation sources of the radiation source device having at least two radiation sources, second emission of radiation from the at least two radiation sources with a target exposure time t_{Z} and/or the target light power l_{Z} of the first and the second radiation source of the radiation source device.

### STATE OF THE ART

The existing methods for the determination of SPF approved by the authorities of the European Union (EU) and the American Food and Drug Administration (FDA) are all harmful to the test person involved by causing erythema, i.e. a light-induced inflammatory reaction of the skin (COLI PA—European Cosmetic, Toiletry and Perfumery Association: Colipa SPF Test Method 94/289, 1994; ISO Standards 24442, 24443, 24444). Therefore, both the FDA and the EU have repeatedly pointed out that future research activities must be directed towards new methods for characterising the protective efficacy of sunscreen agents in order to avoid late effects on the test persons (European Commission, Standardisation Mandate Assigned To CEN Concerning Methods For Testing Efficacy Of Sunscreen Products, M/389 EN, Brussels, 12 Jul. 2006).

This task is to be performed by the present invention. The existing methods are defined in various references:

### I. Procedures Defined in Standards and Regulations:

a. ISO 24444 defines a method for the in vivo determination of SPF. The basis of the method is the generation of erythema on the skin of test persons by radiation in the UVB range. Therefore, the procedure is damaging. In order to reduce the dependence of the result on interindividual variations in skin properties, the procedure must be carried out on several test subjects.
b. ISO 24443 defines an In vitro method for the determination of the UVA protection factor (UVAPF). The sunscreen is applied to a plastic plate so that a transmission spectrum of the sunscreen can be measured. Due to uncontrollable variations in the procedure, the transmission spectrum is adjusted to the result of the erythema test according to ISO 24444 by scaling and is thus dependent on its performance. The plastic plate used is a relatively unrealistic skin model with a roughened surface.
c. ISO 24442 defines an In vivo method in which the UVA protection factor is determined by means of the minimum UVA dose to produce an irreversible pigmentation (sun tan) of the skin. This procedure also requires a change in the skin of the test person.
d. FDA Final Rules 201 1, originally published in the Federal Register on Aug. 27, 2007 (72 FR 49070) and codified as the Broad Spectrum Test (21 CFR 201.327(j)) and Sun Protection Factor (SPF) Test (21 CFR 201.327(i) or in a more recent version as 21 CFR 201.352 (http://www.ecfr.gov/cgi-bin/text-idx? SID=5555a0dd8b6d83a8570676d9a44bb6ef&mc=true&node=pt21.5.352&rgn=div5)

### II. Patented Methods:

a. DE 198 28 497 A1 describes a method in which, as in ISO 24444, erythema is produced in test persons by UV irradiation of the skin. In contrast to ISO 24444, these are detected by reflection spectroscopy. The procedure is thus also harmful. The optical effect (protection) of the sunscreen is not recorded with direct optical measurements, but via a biological reaction of the body.
b. DE 10 2004 020 644 A1 describes a method in which the generation of radicals by UV exposure is quantitatively measured in vivo by means of electron spin resonance (ESR). Here, too, the optical effect of the sunscreen is only indirectly recorded. In addition, the measurement of ESR is technically complex and requires relatively large, stationary devices (table-top devices). They are also sensitive to interference from high-frequency irradiation or rapid temporary magnetic field changes, such as from electrical switching processes.

### III. Publications:

a. In Bendova H, et al, Toxicology in vitro (2007), 1268-1275, transmission spectroscopy methods are compared using different films as skin models. The protective factors determined depend strongly on the film used. A significant correlation of the protection factors with the SPF from ISO 24444 was not found.
b. In Ruvolo E, Kollias N, Cole C, Photodermatol Photoimmunol Photomed (2014), 30: 202-211 a method is presented in which a UVB transmission measurement with plastic substrates and an in vivo backscatter measurement on the skin in the UVA range are combined. The transmittance measurement is adapted to the UVA backscatter measurement by scaling, whereby a good agreement with the in vivo test of the SPF according to ISO 24444 is achieved. The measuring arrangement for the UVA backscatter measurement contains a fibre bundle that is placed on the skin. The measurement is carried out using a large number of illumination and detection fibres at different distances from each other. The sum of the light powers from the detection fibres is detected, so there is no defined distance between the illumination surface and the detection surface, but rather a summation of all distances. In the method according to the invention, the backscattering is measured with several well-defined distances.
c. In Sohn M, Korn V, Imanidis G, Skin Pharmacol Physiol, (2015), 28: 31-41, pig ear skin is tested as a substrate for in vitro transmission measurements. Compared to the measurement with standardised plastic substrates, a better correlation to the SPF determined in vivo is obtained. This shows that a realistic skin model is essential for the determination of protective factors. The transmittance measurement was carried out with/without sunscreen. However, the error of such a measurement is strongly dependent on the layer thickness used (thickness of the separated layer of the pig's ear) and the surface roughness relative to the change due to the (identical, normalised) amount of sunscreen and is only evaluated in the measurements of the publication against the SPF determined in vivo per ISO 24444:2010, not among each other. Also, only one type of sunscreen (oil-in-water) was used, which has specifically high scattering properties due to oil droplet formation, making the surface changes less effective.

The range of application of the previous methods with UVB radiation (solar simulator, i.e. “sun simulator” with predefined wavelength-specific intensity between 290 and 400 nm corresponding to sun radiation at sea level) and with limited possibilities with UVA radiation (erythema formation does not occur as with UVB, higher penetration depth than UVB into the skin=greater volume) is to be extended with the solution according to the invention without restriction to the UVA, UVB, visible and near-infrared respectively infrared range for the determination of corresponding light protection factors.

### Disadvantages of Previous Methods

Increased doses of UV radiation can damage tissue and cellular components. Skin ageing and, in the worst case, skin cancer are known to be the consequences. For decades, an increasing number of new cases of skin cancer has been observed, which is currently around 20000 cases per year in Germany. The main cause is recurrent intensive UV exposure, as occurs during summer holidays, especially in childhood and adolescence.

Existing methods for the evaluation of sunscreens are inadequate, as they are either invasively tested by erythema formation on the test person or non-physiologically tested on plastic carriers as a skin model.

The current in vivo SPF determination has a number of shortcomings. This determination only refers to a spontaneous biological effect (forced sunburn) triggered by UVB radiation. Today, however, it is known that UVA radiation can also lead to severe skin damage and even skin cancer. Furthermore, the determination of SPF is an invasive procedure, since damage in the form of sunburn is induced in the test persons. Therefore, both the American Food and Drug Administration (FDA) and the European Union have repeatedly pointed out that future research activities must be directed towards new methods for characterising the protective effect of sunscreens in order to avoid late effects on the test persons. The in vivo SPF can only be determined in the UVB, whereas long-term damage also occurs through other spectral ranges.

It is therefore the task of the invention to provide a method and a device which, in particular, reduce the load due to the irradiation on the measuring body and at the same time provide high-quality analysis results.

The task is solved by means of the method for determining sun protection factors with a spectroscopic measurement according to claim 1. Advantageous embodiments of the invention are set out in the subclaims.

The method according to the invention for determining sun protection factors has seven method steps: In the first method step, a first control of several radiation sources of a radiation source device having at least two radiation sources is carried out. For this purpose, the individual radiation source is controlled by means of a radiation source control. In the second method step, a first emission of radiation from the at least two radiation sources is carried out. In the third process step, the radiation reflected/remitted by a measuring body is detected. In the fourth step of the method, the sensor sensitivity S_{T} of a detector is determined. In the fifth method step, the target exposure time t_{Z} and/or the target light power l_{Z} for the at least two radiation sources is determined. The target exposure time t_{Z} and/or the target light power l_{Z} is advantageously such that the product of exposure time and light power is below a MED (minimum erythema dose) or below the maximum permissible irradiation (MZB value; for UV radiation). In the sixth method step, a second control of several radiation sources of a radiation source device having at least two radiation sources is carried out. In the seventh method step, a second emission of radiation from the at least two radiation sources is carried out with the target exposure time t_{Z} and/or the target light power of the first and the second radiation source of the radiation source device.

Due to the method according to the invention, only a small light dose below a MED (minimum erythema dose; individual for skin types) or below the maximum permissible irradiation (MZB value; for UV and also other wavelength ranges) is irradiated onto the measuring body by the adapted target light power l_{Z}. Due to these low light doses, the method is also suitable for damage-free in vivo use. This has the advantage that the identical physiological conditions are present for SPF testing and for application in the sun. Advantageously, the method according to the invention also achieves the shortest possible exposure time. Moreover, the method according to the invention is applied non-invasively. Furthermore, the method takes into account the light propagation in the skin and thereby achieves an increased measurement accuracy. The consideration of physiological properties through a more realistic skin model leads to an improvement in the determination of the sun protection factor. Furthermore, an approximation of In-vivo (human skin) and in-vitro tests is possible. In addition, the method can be used for a very wide wavelength range, not limited by lamp spectra, erythema effect spectrum, reactions of the measuring body, etc.

In the sense of this invention, the term radiation source is used in its proper sense as the source of radiation. A radiation source describes such a device that generates the radiation itself. Further devices for conditioning and/or guiding the radiation may be coupled to this radiation source. However, these devices for conditioning and/or guiding the radiation are not part of a radiation source within the meaning of the present invention. Devices for conditioning and/or guiding the radiation may be, for example, monochromators, filters, light guides, mirrors or similar devices. Radiation sources within the meaning of the present invention include lasers, LEDs, lamps and similar devices capable of generating radiation. For the purposes of the present invention, a radiation source device comprises a plurality of radiation sources of the aforementioned type. Devices for conditioning and/or guiding the radiation emitted by the radiation source are not part of the radiation source device for the purposes of the present invention.

Before starting the method according to the invention for determining a sun protection factor, a reference spectrum of each radiation source of the radiation source device is usually recorded. The reference spectrum is recorded by means of a standard sample and serves to determine the wavelength spectrum of each radiation source and its intensity distribution. Advantageously, the reference spectrum is recorded for each measurement to calculate the sun protection factor in order to detect any intensity changes and changes in the wavelength spectrum due to, for example, ageing of the individual radiation sources.

In a further embodiment of the invention, the radiation is generated by the radiation source. After the radiation is generated by the radiation source, the generated radiation is emitted from the radiation source. In an optional embodiment of the invention, the radiation generated and emitted by the radiation source is conditioned and guided by means of devices for conditioning and/or guiding the radiation. Devices for conditioning and/or guiding the radiation may be, for example, monochromators, filters, light guides, mirrors or similar devices. Radiation sources in the sense of the present invention are lasers, LEDs, lamps and similar devices capable of generating radiation.

In a further development according to the invention, the second emission of radiation takes place at the same measuring point as the first emission. The spectral reflectance measurement recorded during the second emission is used to calculate the sun protection factor. For the calculation, the spectral reflectance with and without sunscreen is calculated as described in Throm et al. (THROM, C. M.: In vivo sun protection factor and UVA protection factor determination using (hybrid) diffuse reflectance spectroscopy and a multi-lambda-LED light source. Journal of Biophotonics, Vol. 14 (2), Jun. 10, 2020, pp. 1-8, e202000348. DOI: 10.1002/jbio.202000348).

In a further embodiment of the invention, the exposure time t_{T} of the first emission of radiation from the at least two radiation sources is less than 1 s and/or the light power l_{T} of the first emission from the at least two radiation sources is greater than l_{T}>0.8*lₘₐₓ with lₘₐₓ as the maximum light power of the at least two radiation sources. The first emission of radiation is a test measurement for determining the exposure time t_{T} and the light output l, with which the actual determination of the sun protection factor is carried out. The exposure time t_{T} and the light output l_{T} are selected during the first emission of radiation in such a way that no damage is caused to the skin of a test person. Preferably, the exposure time t_{T} of the first emission is t_{T}<150 ms, particularly preferably t_{T}<50 ms. Preferably, the light output l_{T} of the first emission is l_{T}>0.5*lₘₐₓ, particularly preferably l_{T}>0.1*lₘₐₓ.

In a further development of the invention, the exposure time t_{T} of the first emission of radiation is shorter than the target exposure time t_{Z} of the second emission of radiation from the at least two radiation sources. The exposure time t_{Z} and the light power l_{T} during the first emission of radiation are selected in such a way that no damage is caused to the skin of a subject. The second emission of radiation is the actual determination of the sun protection factor, which is carried out with a longer target exposure time t_{Z}. This reduces the total measurement time of the method according to the invention and at the same time ensures a high accuracy of the determined sun protection factor.

In a further embodiment of the invention, the target exposure time t_{Z} is determined from the sensor sensitivity S_{T} of the first emission of radiation from the at least two radiation sources.

In another embodiment of the invention, the target exposure time t_{Z} is determined from the sensor sensitivity S_{T} of the first emission of radiation from the at least two radiation sources with the relationship t_{Z}=S_{Z}/S_{T}*t_{T} with S_{Z} as the target sensor sensitivity. Due to this correlation, a high signal-to-noise ratio is achieved and at the same time the skin of a test person is not damaged.

In another embodiment of the invention, the target sensor sensitivity S_{Z} is in a range 0.3*IRₘₐₓ<S_{Z}<IRₘₐₓ with IRₘₐₓ as the maximum pulse rate of the sensor. Due to this relationship, a high signal-to-noise ratio is achieved while not damaging the skin of a test person.

In another embodiment of the invention, the first emission of radiation from the at least two radiation sources is performed on a measuring body of the same type as the second emission of radiation from the at least two radiation sources. In order to ensure the comparability of the spectra determined by the first and the second emission of radiation, the measuring body is at least of the same type for both emissions of radiation, i.e. has at least similar absorption and reflection properties. Ideally, however, the first emission of radiation and the second emission of radiation take place on the same position of the skin of a test person.

In a further embodiment of the invention, the first emission of radiation from the at least two radiation sources is performed separately for each radiation source. This is particularly the case if the spectral ranges and/or the light output of the radiation sources differ in such a way that comparability is not or only insufficiently given.

In a further embodiment of the invention, the first emission of radiation from the at least two radiation sources takes place in groups of radiation sources with similar maximum light output. In the context of this document, a radiation source group is understood to mean that a radiation source group has at least one radiation source, but one of the radiation source groups arranged in the radiation source device has at least two radiation sources. Advantageously, radiation sources with similar maximum light output are arranged in a radiation source group in order to achieve comparability of the spectra of the individual radiation sources and/or radiation source groups.

In a further embodiment of the invention, the second emission of radiation from the at least two radiation sources is carried out separately for the at least two radiation sources. This is particularly the case if the spectral ranges and/or the light output of the radiation sources differ in such a way that comparability is not or only insufficiently given.

In a further embodiment of the invention, the second emission of radiation from the at least two radiation sources is performed separately for each radiation source. This is particularly the case if the spectral ranges and/or the light output of the radiation sources differ in such a way that comparability is not or only insufficiently given.

In a further development of the invention, the second emission of radiation from the at least two radiation sources takes place in groups of radiation sources with similar maximum light output. Advantageously, radiation sources with similar maximum light power are arranged in a radiation source group in order to achieve comparability of the spectra of the individual radiation sources and/or radiation source groups.

The task is further solved by the measuring system for determining sun protection factors of sunscreen agents according to claim 17.

The measuring system according to the invention for determining sun protection factors of sunscreen agents comprises a radiation source device which in turn comprises two or more separate radiation sources. The measuring system also has a spectrometer and a control device.

According to the invention, the at least two separate radiation sources can be controlled separately. The measuring system according to the invention enables a targeted adaptation of the overall spectrum to different applications through the targeted control of the radiation sources. By selectively superimposing the individual spectral ranges of the radiation sources, uniform illumination is also achieved both in the UVA wavelength range from 380 nm to 315 nm and in the UVB wavelength range from 315 nm to 280 nm, and thus the selectability of a maximum radiation dose, either in the form of an individual dose (e.g. 0.1 MED) or a limit value, is also achieved. In this way, the radiation dose for a test person is minimised. In addition, the light source can also be used for other measurement tasks, e.g. for measuring the photodegradation of sun protection products, for which a spectrum similar to that of the sun is necessary.

In another embodiment of the invention, the wavelength spectra of the rays emitted by at least two of the separate radiation sources are different. By selectively superimposing the individual spectral ranges of the radiation sources, uniform illumination is achieved both in the UVA wavelength range from 380 nm to 315 nm and in the UVB wavelength range from 315 nm to 280 nm.

In a further embodiment of the invention, the spectrometer is controllable by the control device. Furthermore or additionally, the signals measured by the spectrometer can be processed by the control device.

In a further embodiment of the invention, the radiation source control is suitable and intended for separately controlling the individual radiation sources of the radiation source device. This enables a targeted control of the radiation sources and a targeted adaptation of the overall spectrum to different applications. By selectively superimposing the individual spectral ranges of the radiation sources, a uniform illumination is also achieved and thus the selectability of a maximum radiation dose or a limit value is also achieved.

In a further embodiment of the invention, the wavelength and/or the intensity of the radiation emitted by the individual radiation sources can be controlled separately by means of the radiation source control. This enables a targeted control of the radiation sources and a targeted adaptation of the overall spectrum to different applications. By defined superimposition of the individual spectral ranges of the radiation sources, a uniform illumination is also achieved and thus also the selectability of a maximum radiation dose or a limit value. This minimises the radiation dose for a test person and the light source can also be used for other measurement tasks.

In a further development of the invention, the radiation source control is arranged separately from the control device. The control device is usually a PC or notebook computer with a corresponding computer program and connected to the radiation source control via a data line.

In another embodiment of the invention, the radiation source control is controllable by the control device. The control device is typically a PC or notebook computer with a corresponding computer program and connected to the radiation source control via a data line. The control device controls the wavelength range, the exposure time and/or the intensity of the light emitted by the radiation source device via the radiation source control.

In one embodiment according to the invention, the measuring system comprises radiation sources intended and suitable for generating radiation. In a further embodiment according to the invention, the radiation sources are provided for and suitable for emitting the radiation generated by the radiation sources themselves. In an optional further embodiment of the invention, the measurement system comprises one or more devices for conditioning and/or guiding the radiation. Devices for conditioning and/or guiding the radiation may be, for example, monochromators, filters, light guides, mirrors or similar devices. Radiation sources in the sense of the present invention are lasers, LEDs, lamps and similar devices capable of generating radiation.

Examples of embodiments of the measuring system according to the invention and the method according to the invention are shown schematically in simplified form in the drawings and are explained in more detail in the following description.

Showing:

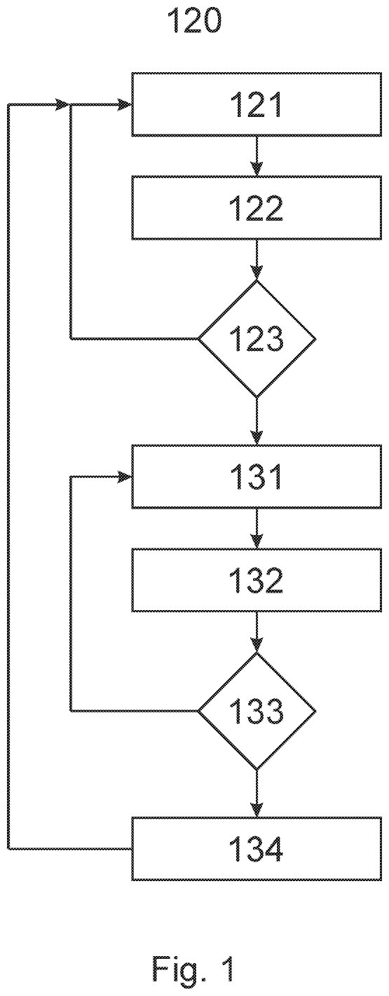

FIG. 1: General procedure for determining the optimal exposure time of the individual radiation sources

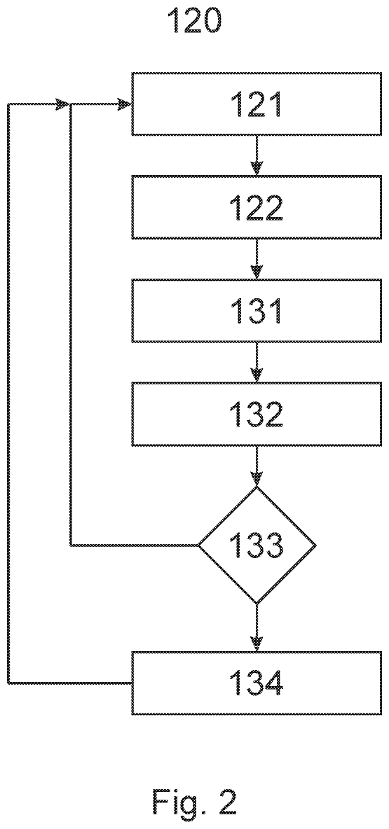

FIG. 2: Alternative procedure for determining the optimal exposure time of the individual radiation sources

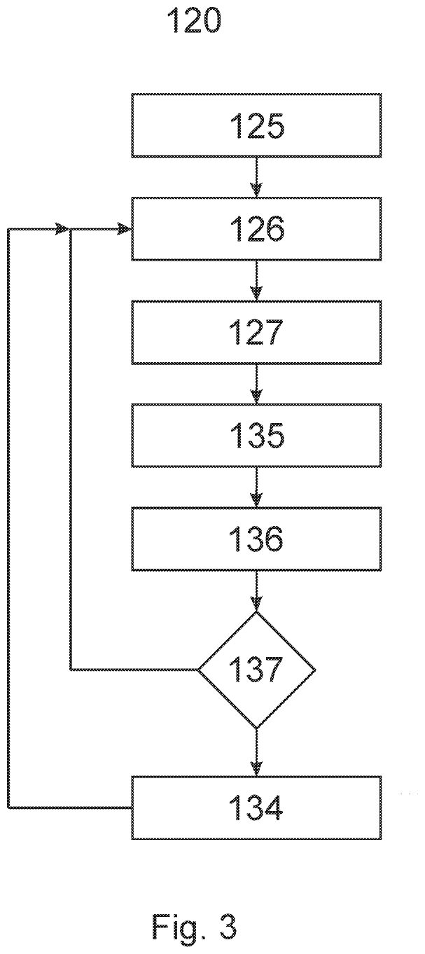

FIG. 3: Procedure with the grouping of radiation sources for the determination of sun protection factors

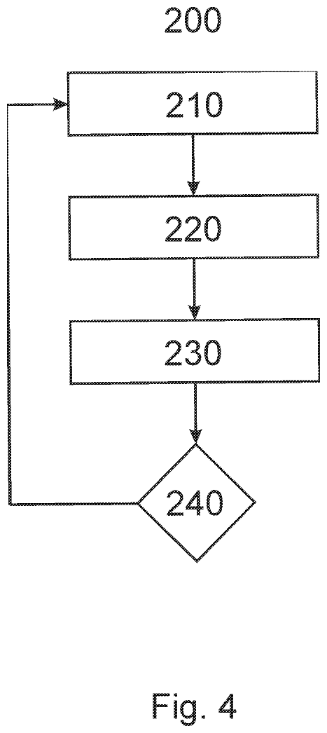

FIG. 4: Procedure for activating the individual radiation sources

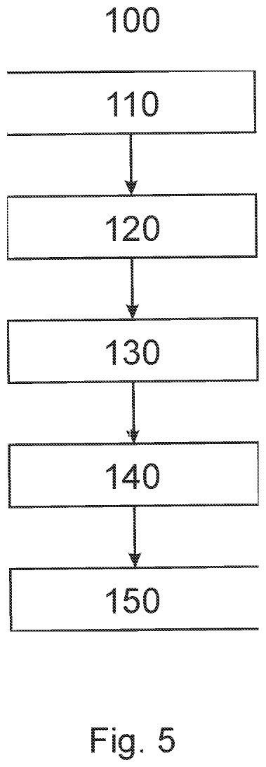

FIG. 5: Procedure for carrying out a measurement to determine sun protection factors

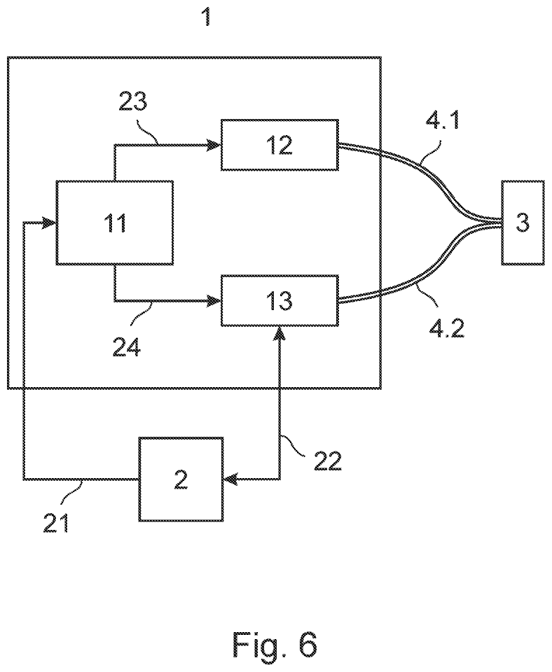

FIG. 6: Measuring system for determining sun protection factors.

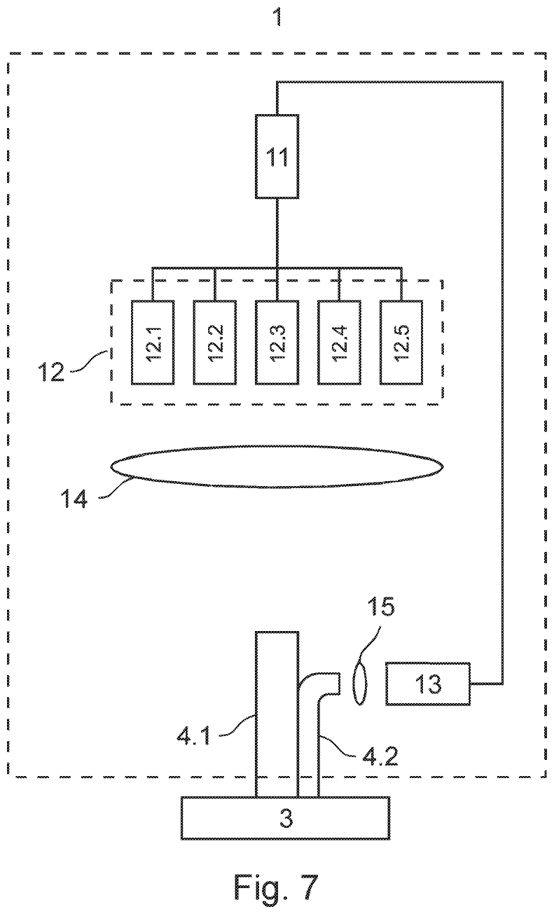

FIG. 7: Radiation source device for determining sun protection factors.

FIG. 1 schematically shows an embodiment example of the method 120 according to the invention, in which a test measurement 121 is carried out for each individual radiation source and then a measurement is carried out to determine a sun protection factor.

At the beginning of the procedure 120, a test spectrum of a single radiation source 12.1, 12.2, 12.3, 12.4, 12.5 is recorded 121. For this purpose, the individual radiation source e.g. 12.1 is controlled by means of the radiation source control 11 (see FIG. 6, 7) in such a way that the radiation source 12.1 emits radiation. The exposure time t_{T} of the test measurement 121 is selected so that the exposure time t_{T} of the radiation is 0.5 s. The light output l_{T} is l_{T}>0.8*lₘₐₓ with lₘₐₓ as the maximum light output. Based on these parameters, the spectrometer 13 has a sensor sensitivity S_{T}.

Then the target exposure time t_{Z} and the light power 122 for the actual sample measurement 131 are determined for the controlled radiation source 12.1. The target exposure time t_{Z} and the target sensor sensitivity S_{Z} are calculated from the sensor sensitivity S_{T} of the spectrometer 13. The relationship between the target exposure time t_{Z} and the target sensor sensitivity S_{Z} is valid. The following relationship applies t_{Z}=S_{Z}/S_{T}*t_{T}. It has also been found that a good signal-to-noise ratio of the spectrometer 13 is obtained when the target sensor sensitivity S_{Z} is in the range between 0.3 times the maximum pulse rate of the spectrometer 13 and its maximum pulse rate. This choice of parameters reduces both the time required for the test measurement 121, for the actual measurement to determine the sun protection factor 131 and the radiation exposure for the test person.

In the next step of the procedure, a query is made as to whether a test spectrum 121 has been recorded for each of the individual radiation sources 12.1, 12.2, 12.3, 12.4, 12.5. If this is not the case, the method 120 starts again with the recording of a test spectrum 121 of a further individual radiation source 12.2. If this is the case, i.e. if a test spectrum is available for each radiation source 12.1, 12.2, 12.3, 12.4, 12.5, a measurement spectrum 131 is recorded by means of an individual radiation source 12.1. For this purpose, the individual radiation source 12.1 is again controlled by means of the radiation source control 11 in such a way that the radiation source 12.1 emits radiation with the parameters for exposure time t_{Z} and light power l_{T} determined in the process step 122. This measurement spectrum is then mathematically filtered by a corresponding software program on the control device 2 (see FIG. 6, 7), preferably by superimposing a trapezoidal function and/or a suitable other filter function on the measurement spectrum.

In the next process step, a query 133 is made as to whether the recording of a measurement spectrum 131 for each of the individual radiation sources 12.1, 12.2, 12.3, 12.4, 12.5 has taken place. If this is not the case, the method 120 starts again with the recording of a measurement spectrum 131 of a further individual radiation source 12.2. If this is the case, i.e. if a measurement spectrum is available for each radiation source 12.1, 12.2, 12.3, 12.4, 12.5, a query 134 is made as to whether the recording of the test spectra 121 and the recording of the measurement spectra 131 was carried out on a sample 3 untreated with sunscreen or on a sample 3 treated with sunscreen. If the recording of the test spectra 121 and the recording of the measurement spectra 131 was performed on a sample 3 untreated with sunscreen, the procedure 120 is performed on a sample 3 treated with sunscreen as described. The sun protection factor is then calculated from the measurement spectra of the sample 3 treated with sunscreen.

The procedure 120 presented here is therefore carried out at the same location on the measurement sample 3, in particular on the skin of a test person. In this way, the reproducibility of the selected parameters of light power and exposure time is guaranteed. The procedure 120 is first performed on a sample 3 untreated with sunscreen and then a second time on a sample 3 treated with sunscreen. Depending on the number of radiation sources 12.1, 12.2, 12.3, 12.4, 12.5 arranged in the radiation source device 12, the procedure requires a time of a few to a few 10 s.

Before starting the method according to the invention for determining a sun protection factor 100, a reference spectrum of each radiation source 12.1 of the radiation source device 12 is usually recorded. The reference spectrum is recorded by means of a standard sample body 3 and serves to determine the wavelength spectrum of each radiation source 12.1, 12.2, 12.3, 12.4, 12.5 and its intensity distribution. Advantageously, the reference spectrum is recorded for each measurement to calculate the sun protection factor in order to detect any intensity changes and changes in the wavelength spectrum due to, for example, ageing of the individual radiation sources 12.1, 12.2, 12.3, 12.4, 12.5.

A possible variant of the previous embodiment of the method 120 according to the invention is shown in FIG. 2. At the beginning of the method 120, a test spectrum of a single radiation source 12.1, 12.2, 12.3, 12.4, 12.5 is recorded 121. For this purpose, the individual radiation source 12.1 is controlled by means of the radiation source control 11 (see FIG. 6, 7) in such a way that the radiation source 12.1 emits radiation. Then the exposure time and the light power 122 for the controlled radiation source 12.1 are determined. In the next process step, a measurement spectrum 131 is recorded by means of a single radiation source 12.1. In the next process step, the recorded measurement spectrum 131 is mathematically filtered 132 by a corresponding software program on the control device 2 (see FIG. 6, 7).

In the next process step, a query 133 is made as to whether a test spectrum 121 and a measurement spectrum 131 have been recorded for each of the individual radiation sources 12.1, 12.2, 12.3, 12.4, 12.5. If this is not the case, the method 120 starts again with the recording of a test spectrum 121 of a further individual radiation source 12.2. If this is the case, i.e. if a test spectrum is available for each radiation source 12.1, 12.2, 12.3, 12.4, 12.5, a query 134 is made as to whether the recording of the test spectra 121 and the recording of the measurement spectra 131 was carried out on a sample 3 untreated with sunscreen or on a sample 3 treated with sunscreen. If the recording of the test spectra 121 and the recording of the measurement spectra 131 was carried out on a sample 3 untreated with sunscreen, the procedure 120 is carried out on a sample 3 treated with sunscreen as described.

The procedure 120 presented here is also carried out like the previous embodiment example on the same location of the measurement sample 3, in particular on the skin of a test person. The procedure 120 is first carried out on a sample 3 untreated with sunscreen and then a second time on a sample 3 treated with sunscreen. Due to the lack of a separate query as to whether a test spectrum has been recorded for all radiation sources arranged in the radiation source device 12 (see FIG. 1, item 123), the measurement time for determining a sun protection factor can be shorter compared to the previous embodiment example.

FIG. 3 shows an embodiment example of the method 120 according to the invention, in which the radiation sources 12.1, 12.2, 12.3, 12.4, 12.5 are divided into groups. The radiation sources 12.1, 12.2, 12.3, 12.4, 12.5 arranged in the radiation source device 12 are first divided into radiation source groups 12.1, 12.2, 12.3, 12.4, 12.5 125. Then, by means of the radiation source control 11 (see FIG. 6,7), an individual radiation source group 12.1 is controlled in such a way that the radiation source group 12.1 emits radiation 126. Then the exposure time and the light power 127 are determined for the controlled radiation source group 12.1. In the next process step, a measurement spectrum 135 is recorded by means of the individual radiation source group 12.1. In the next process step, the recorded measurement spectrum 135 is mathematically filtered 136 by a corresponding software program on the control device 2 (see FIG. 6, 7).

In the next process step, a query 137 is made as to whether a test spectrum 126 and a measurement spectrum 135 have been recorded for each of the individual radiation source groups 12.1, 12.2, 12.3, 12.4, 12.5. If this is not the case, the method 120 starts again with the recording of a test spectrum 126 of a further individual radiation source group 12.2. If this is the case, i.e. if a test spectrum is available for each radiation source group 12.1, 12.2, 12.3, 12.4, 12.5, a query 134 is made as to whether the recording of the test spectra 126 and the recording of the measurement spectra 135 was carried out on a sample 3 untreated with sunscreen or on a sample 3 treated with sunscreen. If the recording of the test spectra 121 and the recording of the measurement spectra 131 was carried out on a sample 3 untreated with sunscreen, the procedure 120 is carried out on a sample 3 treated with sunscreen as described.

By a radiation source group 12.1, 12.2, 12.3, 12.4, 12.5 it is understood in the context of this writing that a radiation source group 12.1, 12.2, 12.3, 12.4, 12.5 comprises at least one radiation source 12.1, 12.2, 12.3, 12.4, 12.5, but one of the radiation source groups 12.1, 12.2, 12.3, 12.4, 12.5 arranged in the radiation source device 12 has at least two radiation sources 12.1, 12.2, 12.3, 12.4, 12.5. Advantageously, radiation sources 12.1, 12.2, 12.3, 12.4, 12.5 with similar maximum light output are arranged in a radiation source group 12.1, 12.2, 12.3, 12.4, 12.5.

The procedure 120 presented here is also carried out like the previous embodiment examples on the same location of the measurement sample 3, in particular on the skin of a test person. The procedure 120 is first carried out on a sample 3 untreated with sunscreen and then a second time on a sample 3 treated with sunscreen.

A general embodiment of the method for recording a spectrum 200 is shown in FIG. 4. The method 200 shown here is used for recording reference spectra as well as for recording test spectra and for recording measurement spectra. In the first process step 210, a radiation source 12.1, 12.2, 12.3, 12.4, 12.5 of the radiation source device 12 or a radiation source group 12.1, 12.2, 12.3, 12.4, 12.5 is controlled and activated. In the next process step 220, a spectrum of the radiation source 12.1, 12.2, 12.3, 12.4, 12.5 activated in the first process step 210 or of the activated radiation source group 12.1, 12.2, 12.3, 12.4, 12.5 is detected. Thereafter, the radiation source 12.1, 12.2, 12.3, 12.4, 12.5 of the radiation source device 12 activated in the first method step 210 or the activated radiation source group 12.1, 12.2, 12.3, 12.4, 12.5 is deactivated 230. In the next method step 240, a query is made as to whether a spectrum has been acquired for each of the radiation sources 12.1, 12.2, 12.3, 12.4, 12.5 of the radiation source device 12. If this is the case, i.e. a spectrum is detected for each radiation source 12.1, 12.2, 12.3, 12.4, 12.5 of the radiation source device 12, the method 200 is terminated. If this is not the case, i.e. a spectrum has not yet been detected for each radiation source 12.1, 12.2, 12.3, 12.4, 12.5 of the radiation source device 12, the method 200 is repeated, starting with the first method step 210, until in method step 240 the query is answered to the effect that a spectrum has been detected for each radiation source 12.1, 12.2, 12.3, 12.4, 12.5 of the radiation source device 12.

FIG. 5 shows an example of an embodiment of the method according to the invention for determining sun protection factors 100. At the beginning of the method according to the invention for determining a sun protection factor 100, a reference spectrum of each radiation source 12.1, 12.2, 12.3, 12.4, 12.5 of the radiation source device 12 is usually recorded 110. The recording of the reference spectrum is usually carried out by means of a standard sample body 3 and serves to determine the wavelength spectrum of each radiation source 12.1, 12.2, 12.3, 12.4, 12.5 and its intensity distribution. Advantageously, the reference spectrum 110 is recorded during each measurement to calculate the sun protection factor 100 in order to detect any intensity changes and changes in the wavelength spectrum due to, for example, ageing of the individual radiation sources 12.1, 12.2, 12.3, 12.4, 12.5. Thereafter, a test measurement of the radiation source device 12 is performed using a measuring body 3 120. The test measurement includes a first activation of the radiation source device 12, a first emission of radiation from the radiation source device 12, the detection of the radiation diffusely reflected by a measuring body and the determination of the sensor sensitivity S_{T} of a detector 13 as well as the determination of the target exposure time t_{Z} and/or the target light power l_{Z} for the radiation source device 12. Detailed explanations of the test measurement 120 are set out in previous embodiment examples (FIGS. 1-3).

In the next process step, recording of the measurement spectrum, 130 the spectrum determined by means of the test measurement 120 is irradiated onto the sample 3 by means of a second activation of the radiation source device 12, a total spectrum is composed of the partial spectra of the individual radiation sources 12.1, 12.2, 12.3, 12.4, 12.5 140 and the sun protection factor is calculated 150. For this purpose, a point on the inside of the forearm or the back of a test person 3 is usually exposed. This measuring location 3 is measured with the measuring system 1 by irradiating light at a defined area of about 500 μm diameter—generated, for example, by placing an optical fibre 4.1 (illumination fibre) with a core diameter of 500 μm. Smaller core diameters of, for example, 200 μm, 100 μm or 50 μm are also possible. The irradiation takes place with an intensity that does not cause acute damage to the skin, which is below the simple MED, or below the MZB values, or significantly below the values caused by solar radiation. 1 MED corresponds to the lowest irradiation dose that caused a sharply defined erythema (reddening) of the skin when read after 24 hours.

This light passes through the skin of the test person and emerges at a distance from a detection surface, which in turn consists of an attached optical fibre. To increase the sensitivity or further reduce the illumination intensity, several detection fibres 4.1, 4.2 can be arranged at the same or at least similar distance from the edge of the illumination fibre in an optical measuring head which is in direct contact with the measuring location 3 and guided together onto a detection device and thus the intensity measured. Depending on the level of intensity and the selected detector 13, the signal generated by the radiation is amplified by a defined factor which also provides a signal above the noise for the subsequent measurement of the weaker intensity. The detection is wavelength-resolved. The resolution can be 1 nm, for example, and is to be selected depending on the definition of the light protection factor.

Furthermore, a repetition of the individual measurements during a measurement cycle is conceivable, whereby the individual measurements are averaged or accumulated. Furthermore, several measurements can be carried out periodically, for example every 5 seconds, and analysed until the deviation of the successive values is below the simple standard deviation, i.e. shows stable values. Such an evaluation takes place in the control device 2, which stops the measurement when the stable values are reached and signals this to a user.

In a variation of one of the above embodiments, a further measurement is also to be carried out at another measuring location 3 in the same way. This makes it possible to compare the light protection factor of the same radiation protection agent with the same type of application at different measuring locations 3.

FIG. 6 schematically shows an embodiment of the measuring system 1 according to the invention. The measuring system 1 has a radiation source device 12 with several radiation sources 12.1, 12.2, 12.3, 12.4, 12.5, 12.6, 12.7, 12.8. By means of a light guide 4.1 the spectrum emitted by the radiation source device 12 is introduced into the sample 3, the light reflected by the sample 3 reaches the spectrometer 13 via a further light guide 4.2. Spectrometer 13 and radiation source device 12 are connected via data lines 23, 24 to a radiation source control 11, which in turn is connected via a further data line 21 to the externally arranged control device 2. The control device 2 is usually a PC or notebook computer with a corresponding computer program. The control device 2 and the spectrometer 13 are also connected to each other via a data line 22.

The method for determining sun protection factors comprises a first activation of several radiation sources of a radiation source device having at least two radiation sources as well as a first emission of radiation from the at least two radiation sources. Subsequently, a detection of the radiation diffusely reflected by a measuring body takes place. Then the sensor sensitivity S_{T} of a detector is determined and the target exposure time t_{Z} and/or the target light power l_{Z} for the at least two radiation sources is determined. Thereafter, a second triggering of several radiation sources of the radiation source device comprising at least two radiation sources takes place and a second emission of radiation (to the same measuring point as during the first emission) from the at least two radiation sources with a target exposure time t_{Z} and/or the light power l_{Z} of the first and the second radiation source of the radiation source device. The spectral reflectance measurement taken during the second emission is used for the calculation of the sun protection factor.

A detailed view of an embodiment of the measuring system 1 according to the invention is shown in FIG. 7. The measuring system 1 has a radiation source device 12 with five radiation sources 12.1, 12.2, 12.3, 12.4, 12.5. The radiation sources 12.1, 12.2, 12.3, 12.4, 12.5 are advantageously LEDs which have a particularly long service life. The spectral ranges of the individual LEDs differ from each other in such a way that a spectral range is covered, in particular in the UVA (315-380 nm) and UVB range (280-315 nm). The light emitted by the radiation sources 12.1, 12.2, 12.3, 12.4, 12.5 is bundled by a lens system 14, coupled into the light guide 4.1 and directed onto the sample 3. The light reflected by the sample 3 reaches the spectrometer 13 via a further light guide 4.2 through a further lens system 15. Spectrometer 13 and radiation source device 12 are connected via data line 24 to the radiation source control 11, which in turn is connected via a further data line to the externally arranged control device 2 (not shown, see FIG. 6). The radiation source control 11 controls the intensity and wavelengths of the radiation source device 12 and receives the data from the spectrometer 13 for this purpose.

The method for determining sun protection factors 100 comprises a first activation of several radiation sources of a radiation source device comprising at least two radiation sources as well as a first emission of radiation from the at least two radiation sources. Subsequently, a detection of the radiation diffusely reflected by a measuring body takes place. Then the sensor sensitivity S_{T} of a detector is determined and the target exposure time t_{Z} and/or the target light power l_{Z} for the at least two radiation sources is determined 122. Then a second control of several radiation sources of the radiation source device having at least two radiation sources takes place and a second emission of radiation (to the same measuring point as during the first emission) from the at least two radiation sources with a target exposure time t_{Z} and/or the light power l_{Z} of the first and the second radiation source of the radiation source device. The spectral reflectance measurement taken during the second emission is used for the calculation of the sun protection factor.

### REFERENCE LIST

1 Measuring system
2 Control device
3 Sample/measuring body
4.1, 4.2 Light fibre/fibre bundle
11 Radiation source control
12 Radiation source device
12.1, 12.2, 12.3, 12.4, 12.5, 12.6, 12.7, 12.8 Radiation source/LED
13 Detector/Spectrometer
14 Lens system
14.1, 14.2, 14.3, 14.4, 14.5, 14.9 Lens
15 Lens
21 Connection radiation source control—radiation source device
22 Connection detector/spectrometer—control device
23 Connection radiation source control—control device
24 Connection radiation source control—detector/spectrometer
100 Method for the determination of sun protection factors
110 Recording a reference spectrum
120 Method for determining the target exposure time and/or the target light power
121 Recording a test spectrum for a radiation source
122 Determination of the target exposure time t_{Z} and/or the target light output l_{Z}
123 Query whether test spectra have been recorded for all radiation sources
125 Grouping of radiation sources
126 Recording of a test spectrum of a radiation source group
127 Determining the target exposure time t_{Z} and/or the target light power l_{Z} of the radiation source group
130 Method for recording a measurement spectrum
131 Recording a measurement spectrum
132 Filtering the measurement spectrum
133 Query whether a test spectrum has been recorded for each radiation source
134 Query whether the recording of a test spectrum for an untreated and sunscreen-treated measurement position has been made.
135 Recording a measurement spectrum with a radiation source group
136 Filtering the measurement spectra of the radiation source groups
137 Query whether a test spectrum has been recorded for each radiation source group
140 Composing an overall spectrum
150 Calculation of the sun protection factor
200 Method for recording a spectrum
210 Activating a radiation source
220 Recording a spectrum
230 Deactivating the previously activated radiation source
240 Query whether a spectrum has been recorded for each radiation source

1. Method for determining sun protection factors of sunscreen agents (100) with a spectroscopic measurement with the method steps:
First actuation of several radiation sources (12.1, 12.2, 12.3, 12.4, 12.5, 12.6, 12.7, 12.8) of a radiation source device comprising at least two radiation sources (12.1, 12.2, 12.3, 12.4, 12.5, 12.6, 12.7, 12.8)
First emission of radiation from the at least two radiation sources (12.1, 12.2, 12.3, 12.4, 12.5, 12.6, 12.7, 12.8)
Detection of the radiation remitted/reflected by a measuring body
Determination of the sensor sensitivity S_{T} of a detector
Determining the target exposure time t_{Z} and/or the target light power l_{Z} for the at least two radiation sources (12.1, 12.2, 12.3, 12.4, 12.5, 12.6, 12.7, 12.8)
Second actuation of several radiation sources of the radiation source device comprising at least two radiation sources (12.1, 12.2, 12.3, 12.4, 12.5, 12.6, 12.7, 12.8)
Second emission of radiation from the at least two radiation sources (12.1, 12.2, 12.3, 12.4, 12.5, 12.6, 12.7, 12.8) with a target exposure time t_{Z} and/or the target light power l_{Z} of the first and the second radiation source (12.1, 12.2, 12.3, 12.4, 12.5, 12.6, 12.7, 12.8) of the radiation source device.

2. Method for determining sun protection factors of sunscreen agents (100) with a spectroscopic measurement according to claim 1
characterised in that
the exposure time t_{T} of the first emission of radiation from the at least two radiation sources (12.1, 12.2, 12.3, 12.4, 12.5, 12.6, 12.7, 12.8) is less than 0.5 s and/or
the light output l_{T} of the first emission from the at least two radiation sources (12.1, 12.2, 12.3, 12.4, 12.5, 12.6, 12.7, 12.8) is greater than l_{T}>0.8*lₘₐₓ with lₘₐₓ as the maximum light output of the at least two radiation sources (12.1, 12.2, 12.3, 12.4, 12.5, 12.6, 12.7, 12.8).

3. Method for determining sun protection factors of sunscreen agents (100) with a spectroscopic measurement according to claim 1,
characterised in that
the exposure time t_{T} of the first emission of radiation is smaller than the target exposure time t_{Z} of the second emission of radiation from the at least two radiation sources (12.1, 12.2, 12.3, 12.4, 12.5, 12.6, 12.7, 12.8).

4. Method for determining sun protection factors of sunscreen agents (100) with a spectroscopic measurement according to claim 1,
characterised in that
the target exposure time t_{Z} is determined from the sensor sensitivity S_{T} of the first emission of radiation from the at least two radiation sources (12.1, 12.2, 12.3, 12.4, 12.5, 12.6, 12.7, 12.8).

5. Method for determining sun protection factors of sunscreen agents (100) with a spectroscopic measurement according to claim 4
characterised in that
the target exposure time t_{Z} from the sensor control S_{T} of the first emission of radiation from the at least two radiation sources (12.1, 12.2, 12.3, 12.4, 12.5, 12.6, 12.7, 12.8) from the relation
t_{Z}=S_{Z}/S_{T}*t_{T}
is determined with S_{Z} as the target sensor sensitivity.

6. Method for determining sun protection factors of sunscreen agents (100) with a spectroscopic measurement according to claim 4,
characterised in that
the target sensor sensitivity S_{Z} in a range
0.3*IRₘₐₓ<S_{Z}<IRₘₐₓ
with IRₘₐₓ as the maximum pulse rate of the sensor.

7. Method for determining sun protection factors of sunscreen agents (100) with a spectroscopic measurement according to claim 1,
characterised in that
the first emission of radiation from the at least two radiation sources (12.1, 12.2, 12.3, 12.4, 12.5, 12.6, 12.7, 12.8) onto a measuring body is of the same type as the second emission of radiation from the at least two radiation sources (12.1, 12.2, 12.3, 12.4, 12.5, 12.6, 12.7, 12.8).

8. Method for determining sun protection factors of sunscreen agents (100) with a spectroscopic measurement according to claim 1,
characterised in that
the first emission of radiation from the at least two radiation sources (12.1, 12.2, 12.3, 12.4, 12.5, 12.6, 12.7, 12.8) takes place on the same measuring body as the second emission of radiation from the at least two radiation sources (12.1, 12.2, 12.3, 12.4, 12.5, 12.6, 12.7, 12.8).

9. Method for determining sun protection factors of sunscreen agents (100) with a spectroscopic measurement according to claim 8
characterised in that
the first emission of radiation from the at least two radiation sources (12.1, 12.2, 12.3, 12.4, 12.5, 12.6, 12.7, 12.8) occurs at the same measuring position of the measuring body as the second emission of radiation from the at least two radiation sources (12.1, 12.2, 12.3, 12.4, 12.5, 12.6, 12.7, 12.8).

10. Method for determining sun protection factors of sunscreen agents (100) with a spectroscopic measurement according to claim 1,
characterised in that
the target exposure time t_{Z1} and/or the target light power l_{Z1} of the first radiation source (12.1, 12.2, 12.3, 12.4, 12.5, 12.6, 12.7, 12.8) is different from the target exposure time t_{Z2} and/or the target light power l_{Z2} of the second radiation source (12.1, 12.2, 12.3, 12.4, 12.5, 12.6, 12.7, 12.8).

11. Method for determining sun protection factors of sunscreen agents (100) with a spectroscopic measurement according to claim 1,
characterised in that
the first emission of radiation from the at least two radiation sources (12.1, 12.2, 12.3, 12.4, 12.5, 12.6, 12.7, 12.8) is performed separately for the at least two radiation sources (12.1, 12.2, 12.3, 12.4, 12.5, 12.6, 12.7, 12.8).

12. Method for determining sun protection factors of sunscreen agents (100) with a spectroscopic measurement according to claim 11
characterised in that
the first emission of radiation from the at least two radiation sources (12.1, 12.2, 12.3, 12.4, 12.5, 12.6, 12.7, 12.8) is performed separately for each radiation source.

13. Method for determining sun protection factors of sunscreen agents (100) with a spectroscopic measurement according to claim 11,
characterised in that
the first emission of radiation from the at least two radiation sources (12.1, 12.2, 12.3, 12.4, 12.5, 12.6, 12.7, 12.8) takes place in groups of radiation sources (12.1, 12.2, 12.3, 12.4, 12.5, 12.6, 12.7, 12.8) with similar maximum light output.

14. Method for determining sun protection factors of sunscreen agents (100) with a spectroscopic measurement according to claim 1,
characterised in that
the second emission of radiation from the at least two radiation sources (12.1, 12.2, 12.3, 12.4, 12.5, 12.6, 12.7, 12.8) is performed separately for the at least two radiation sources (12.1, 12.2, 12.3, 12.4, 12.5, 12.6, 12.7, 12.8).

15. Method for determining sun protection factors of sunscreen agents (100) with a spectroscopic measurement according to claim 14
characterised in that
the second emission of radiation from the at least two radiation sources (12.1, 12.2, 15 12.3, 12.4, 12.5, 12.6, 12.7, 12.8) is performed separately for each radiation source (12.1, 12.2, 12.3, 12.4, 12.5, 12.6, 12.7, 12.8).

16. Method for determining sun protection factors of sunscreen agents (100) with a spectroscopic measurement according to claim 14
characterised in that
the second emission of radiation from the at least two radiation sources takes place in groups of radiation sources with similar maximum light output.

17. Method for determining sun protection factors of sunscreen agents (100) with a spectroscopic measurement according to claim 1,
characterised in that
the radiation is generated by the radiation source.

18. Method for determining sun protection factors of sunscreen agents (100) with a spectroscopic measurement according to claim 17
characterised in that
after the radiation is generated by the radiation source, the generated radiation is emitted by the radiation source.

19. Method for determining sun protection factors of sunscreen agents (100) with a spectroscopic measurement according to claim 17
characterised in that
the radiation generated and emitted by the radiation source is conditioned and guided by means of devices for conditioning and/or guiding the radiation.

20. Measuring system (1) for determining sun protection factors of sunscreen agents, which has the following components
a radiation source device (12)
wherein the radiation source device (12) comprises two or more separate radiation sources (12.1, 12.2, 12.3, 12.4, 12.5, 12.6, 12.7, 12.8),
a spectrometer (13)
a control device (2)
characterised in that
the at least two separate radiation sources (12.1, 12.2, 12.3, 12.4, 12.5, 12.6, 12.7, 12.8) can be controlled separately.

21. Measuring system (1) for determining sun protection factors of sunscreen agents, according to claim 20
characterised in that
the wavelength spectra of the ray emitted by at least two of the separate radiation sources (12.1, 12.2, 12.3, 12.4, 12.5, 12.6, 12.7, 12.8) are different.

22. Measuring system (1) for determining sun protection factors of sunscreen agents according to claim 20
characterised in that
the spectrometer (13) can be controlled by the control device (2) and/or the signals measured by the spectrometer (13) can be processed by the control device (2).

23. Measuring system (1) for determining sun protection factors of sunscreen agents according to claim 20
characterised in that
the individual radiation sources (12.1, 12.2, 12.3, 12.4, 12.5, 12.6, 12.7, 12.8) of the radiation source device (12) are separately controllable.

24. Measuring system (1) for determining sun protection factors of sunscreen agents according to claim 20
characterised in that
the measuring system (1) has a radiation source control (11) which is suitable for controlling the radiation source device (12).

25. Measuring system (1) for determining sun protection factors of sunscreen agents according to claim 24
characterised in that
the radiation source control (11) is suitable and intended for separately controlling the individual radiation sources (12.1, 12.2, 12.3, 12.4, 12.5, 12.6, 12.7, 12.8) of the radiation source device (12).

26. Measuring system (1) for determining sun protection factors of sunscreen agents according to claim 24
characterised in that
by means of the radiation source control (11), the wavelength and/or the intensity of the radiation emitted by the individual radiation sources (12.1, 12.2, 12.3, 12.4, 12.5, 12.6, 12.7, 12.8) can be controlled separately.

27. Measuring system (1) for determining sun protection factors of sunscreen agents according to claim 24
characterised in that
the radiation source control (11) is arranged separately from the control device (2).

28. Measuring system for determining sun protection factors of sunscreen agents according to claim 24
characterised in that
the radiation source control (11) can be controlled by the control device (2).

29. Measuring system (1) for determining sun protection factors of sunscreen agents according to claim 24
characterised in that
the radiation source controller (11) is connected to the spectrometer (13) and is suitable and intended to receive signals from the spectrometer (13) and/or to send control commands to the spectrometer (13).

30. Measuring system (1) for determining sun protection factors of sunscreen agents according to claim 20
characterised in that
the radiation sources are intended and suitable for producing radiation.

31. Measuring system (1) for determining sun protection factors of sunscreen agents according to claim 30
characterised in that
the radiation sources are intended and suitable for emitting the radiation produced by the radiation sources themselves.

32. Measuring system (1) for determining sun protection factors of sunscreen agents according to claim 30
characterised in that
the measuring system (1) has one or more devices for conditioning and/or guiding the radiation.
